(19) United States
(12) Patent Application Publication
(10) Pub. No.: US 2011/0149682 A1
(43) Pub. Date: Jun. 23, 2011

(54) Method and apparatus for positioning of seismic cables

(76) Inventors: James Edward Martin, Kanagawa (JP); Svein Arne Frivik, Oslo (NO); Peter Tyler, Leicestershire (GB); Kyrre Tjoem, Asker (NO)

(21) Appl. No.: 10/530,695

(22) PCT Filed: Oct. 13, 2003
(86) PCT No.: PCT/GB2003/004499

§ 371 Date: Feb. 13, 2006

(30) Foreign Application Priority Data
Oct. 11, 2002 (GB) 0223673.5

(51) Int. Cl. G01V 1/38

(52) U.S. Cl. 367/19; 367/20

(57) ABSTRACT

The present invention provides a method and apparatus for determining the position of a seismic cable being used to perform a marine seismic survey. The apparatus includes at least one seismic sensor and a plurality of sources deployed in a manner that is structurally independent of the seismic sensors and adapted to provide a positioning signal distinguishable from a seismic survey signal to the seismic sensors.

### BACKGROUND OF THE INVENTION

1. Field of the Invention

This invention relates to marine seismic surveying, and is more particularly concerned with a method and apparatus for determining the position of a seismic cable being used to perform a marine seismic survey.

2. Description of the Related Art

Seismic exploration is widely used to locate and/or survey subterranean geological formations for hydrocarbon deposits. As many commercially valuable hydrocarbon deposits are located beneath bodies of water, various types of marine seismic surveys have been developed. In a typical marine seismic survey, an array of marine seismic streamer cables is towed at about 5 knots behind a seismic survey vessel. The seismic streamer cables may be several thousand meters long and contain a large number of sensors, such as hydrophones and associated electronic equipment, which are distributed along the length of the each seismic streamer. The survey vessel also tows one or more seismic sources, such as airguns and the like.

Acoustic signals, or “shots,” produced by the seismic sources are directed down through the water into the earth beneath, where they are reflected from the various earth strata. The reflected signals are received by the hydrophones in the seismic streamer cables, digitised and then transmitted to the seismic survey vessel, where they are recorded and at least partially processed with the ultimate aim of building up a representation of the earth strata in the area being surveyed. Analysis of the representation may indicate probable locations of geological formations and hydrocarbon deposits.

The accuracy of the seismic analysis is generally limited by uncertainties in the estimated and/or measured positions of the seismic sensors. The positions of deployed seismic sensors may be estimated using modelling techniques that predict the position of the deployed seismic sources. For example, the position of a seismic cable on the sea floor may be estimated using models that consider the physical characteristics of the seismic cable (e.g., weight, diameter, etc.) and the effect of predicted sea currents on the seismic cable as it descends to the sea floor. However, such methods are predicated on a limited knowledge of the properties of water in the catenary, as well as the geology of the sea floor, and thus they only provide an estimate of the seismic cable's location.

A variety of measurement techniques have been developed to determine the position of the seismic sources and the seismic sensors as the seismic sensors descend through the catenary and come to rest on the sea floor. For example, the seismic source is fired and the arrival time of the shot at the sensors is then used to determine the position of the seismic cable by triangulation. This technique cannot generally be used during a survey, however, because the shots used to determine the position of the seismic sensors often interferes with the shots used to generate the seismic survey data. Alternatively, acoustic signals produced by a seismic source survey array may be used to determine the seismic cable position. However, in addition to producing shots that interfere with the seismic survey data, the large area of the seismic source array used in this technique generally reduces the accuracy of the seismic cable position determination.

The position of seismic cables may also be measured by attaching ultra-short baseline (USBL) acoustic sensors to the seismic cable. The USBL acoustic sensors are suspended above the seismic cable using flotation collars. Although the USBL acoustic sensors can provide reasonably accurate ranges and bearings from the seismic survey vessel, there remain a number of drawbacks to the use of USBL acoustic sensors. The USBL acoustic sensors are generally very expensive and are attached to the outside of the seismic cable, where they may interfere with seismic cable deployment. In addition, USBL acoustic sensors are typically depth-limited and they require an external source of power and/or a battery.

### SUMMARY OF THE INVENTION

In one aspect of the instant invention, an apparatus is provided for determining the position of a seismic cable being used to perform a marine seismic survey. The apparatus includes at least one seismic sensor and a plurality of sources deployed in a manner that is structurally independent of the seismic sensors and adapted to provide a positioning signal distinguishable from a seismic survey signal to the seismic sensors.

In one aspect of the present invention, a method is provided for determining the position of a seismic cable being used to perform a marine seismic survey. The method includes transmitting a plurality of positioning signals from a plurality of sources deployed in a manner that is structurally independent of the seismic sensors, the positioning signals being distinguishable from the seismic survey signal. The method further includes receiving the positioning signals at the seismic sensors and determining the position of the seismic sensors from the received positioning signals.

### BRIEF DESCRIPTION OF THE DRAWINGS

The invention may be understood by reference to the following description taken in conjunction with the accompanying drawings, in which like reference numerals identify like elements, and in which:

FIGS. 1A-B show different views of a first exemplary system for positioning of a seismic cable, in accordance with a first embodiment of the present invention;

FIG. 2 shows a second exemplary system for positioning of the seismic cable, in accordance with a second embodiment of the present invention;

FIG. 3 shows a third exemplary system for positioning of the seismic cable, in accordance with a third embodiment of the present invention;

FIG. 4 shows a system for transmitting signals that are used to determine a position of the seismic cable shown in FIGS. 1A-B, 2, and 3;

FIGS. 5A-B show first and second exemplary piezoelectric acoustic sources that may be used in the system shown in FIG. 4; and

FIG. 6 shows a flow chart illustrating a technique for determining the locations of the sensors.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

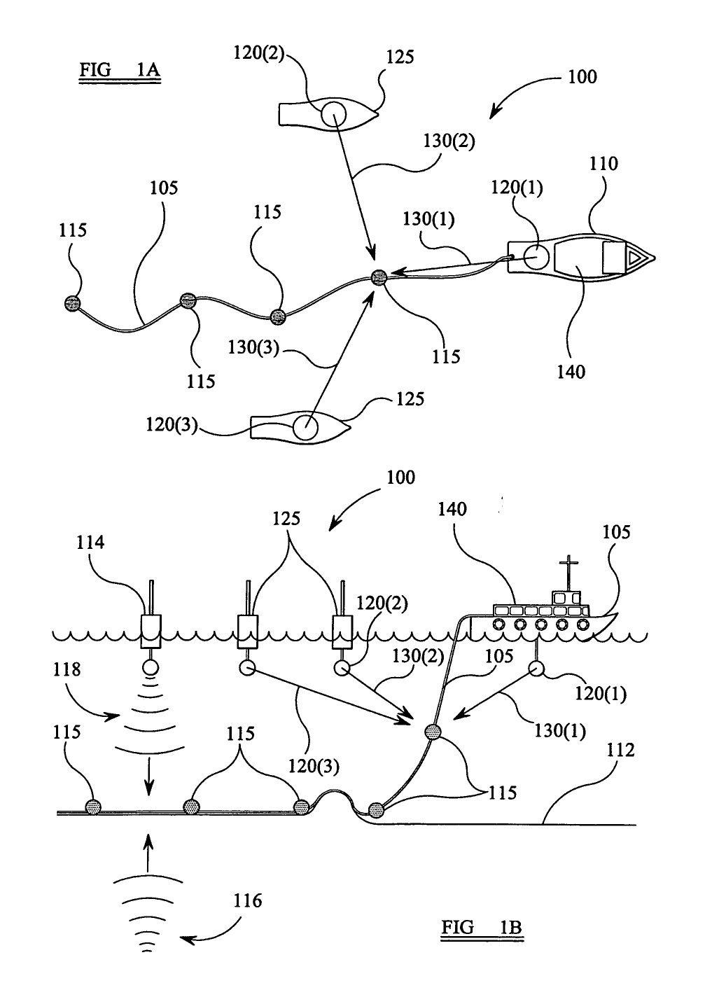

Referring now to FIG. 1A, a top view of a first exemplary system 100 for acoustic positioning of a seismic cable 105 is shown. The first exemplary system 100 includes a seismic survey vessel 110, which deploys the seismic cable 105 at a surface of a body of water, which, in alternative embodiments, may be freshwater, sea water, or brackish water. A plurality of seismic sensors 115 are coupled to the seismic cables 105. In one embodiment, the seismic cable 105 may be a streamer cable that remains at the surface of the body of water. However, in alternative embodiments, the seismic cable 105 may also descend through the catenary until it reaches the sea floor 112, as illustrated in FIG. 1B. Although only one seismic cable 105 is shown in FIGS. 1A-B, the present invention is not so limited. In alternative embodiments, more seismic cables 105 may be deployed without departing from the scope of the present invention. In particular, an array of seismic cables 105 may be deployed.

In one embodiment of the first exemplary system 100, illustrated in FIG. 1B, a seismic source 114 is deployed near the survey vessel 110. The seismic source 114 is generally towed behind the survey vessel 110 and may be part of an array of other seismic sources (not shown). However, it will be appreciated that, in alternative embodiments, the seismic source 114 may be deployed at any desirable location, including an array towed by a nearby vessel (not shown), suspended beneath the survey vessel 110, on a buoy (not shown), at the sea floor 112, and the like.

The seismic source 114 provides a seismic survey signal 118. In one embodiment, the seismic survey signal 118 is a broadband acoustic signal with a range of frequencies from 0 to about 120 Hz. The seismic survey signal 118 propagates into the earth and forms a reflected signal 116 when the seismic survey signal 118 reflects from geologic formations, such as hydrocarbon deposits As shown in FIG. 1B, in one embodiment, the seismic sensors 115 receive the reflected signals 116. As discussed above, analysis of the reflected signals 116 received by the seismic sensors 115 is used to form a representation of the earth strata proximate to the seismic sensors 115 and thus to locate and/or survey geologic formations.

The accuracy of the analysis of the reflected signals 116 depends upon an accurate knowledge of the position of the seismic cable 105. The position of the seismic cable 105 is, however, difficult to determine. During and after deployment of the seismic cables 105, the size and shape of the seismic cable 105, currents in the body of water, the velocity of the survey vessel 110, and other like factors may cause the seismic cable 105 to move unpredictably through the water. Thus, in accordance with one embodiment of the present invention, a plurality of sources 120(1-3) transmit a plurality of positioning signals 130(1-3) to the seismic sensors 115, which receive the positioning signals 130(1-3). In one embodiment, the positioning signals 130(1-3) are acoustic signals. However, the present invention is not so limited. In alternative embodiments of the present invention, any desirable positioning signal 130(1-3) may be used, including, but not limited to, optical signals, radar signals, and the like.

In one embodiment, a first source 120(1) is suspended beneath the survey vessel 110. In alternative embodiments, the first source 120(1) may be mounted in a hull of the survey vessel 110 or in a through-hull chamber of the survey vessel 110. A second and a third source 120(2-3) are suspended beneath buoys 125. In various embodiments, the buoys 125 may be stationary or they may be autonomous, remote-controlled self-powered buoys 125 that follow the survey vessel 110. In one embodiment, the autonomous, remote-controlled self-powered buoys 125 follow the survey vessel 110 and maintain a fixed configuration. In one embodiment, the buoys 125 may be deployed along a length or the seismic cable 105 or amongst an array of seismic cables 105. Note that at least two of the seismic sources 120(1-3) are deployed in a manner structurally independent of the cable 105, i.e., there is no structural relationship between the source 114 and the seismic cable 105.

Although three sources 120(1-3) and two buoys 125 are depicted in FIG. 1A, the present invention is not so limited. Two or more sources 120(1-3) and any desirable number of buoys 125 may be deployed without departing from the scope of the present invention. For example, two sources 120(1-3) may be deployed in a linear grouping. For another example, four sources 120(1-3) may be deployed in an approximately rectangular grouping. For yet another example, five sources 120(1-3) may be deployed in an approximately pentagonal grouping. Furthermore, in alternative embodiments, additional sources 120(1-3) may also be positioned on, or controlled by, a second survey vessel (not shown).

As described in detail below and in accordance with one aspect of the present invention, the positioning signals 130(1-3) may be formed such that a signal processing unit 140 can distinguish between the positioning signals 130(1-3) and seismic survey signal 118. For example, in one embodiment, the positioning signals 130(1-3) have frequencies ranging from 700 HZ to 4500 Hz when the seismic survey signal 118 has a frequency range of 0 to 120 Hz. However, it will be appreciated by those of ordinary skill in the art having benefit of the present disclosure that the positioning signals 130(1-3) and seismic survey signal 118 do not have to be distinguished by frequency. For example, in alternative embodiments, the positioning signals 130(1-3) and seismic survey signal 118 may be distinguished by being modulated by orthogonal sequences, such as a Maximal sequence or a Kasami sequence.

The signal processing unit 140 determines the position of the seismic sensors 115 using the positioning signals 130(1-3) that are transmitted by the sources 120(1-3) and received by the seismic sensors 115. Although the signal processing unit 140 depicted in FIGS. 1A-B is located on the survey vessel 110, the present invention is not so limited. In alternative embodiments, portions of the signal processing unit 140 may be positioned in the seismic sensors 115, the buoys 125, or at any other desirable location without departing from the scope of the present invention. It will further be appreciated by those of ordinary skill in the art having benefit of the present disclosure that the accuracy of the position determination depends on the number and type of sources 120(1-3) and seismic sensors 115. Thus, the phrase “determining the position” of the seismic sensors 115 and/or the seismic cable 105, will hereinafter be understood to mean determining the position of the seismic sensors 115 and/or the seismic cable 105 within a reasonable range of positions.

Referring now to FIG. 2, a second exemplary system 200 for positioning of the seismic cable 105 is shown. In one embodiment of the second exemplary system 200, the sources 120(2-3) are suspended beneath buoys 125, which are coupled to the survey vessel 110 by cables 210. However, the present invention is not so limited. In one alternative embodiment of the second exemplary system 200, the sources 120(2-3) are mounted in the hulls of the buoys 125. In another alternative embodiment of the second exemplary system 200, the sources 120(2-3) are suspended beneath, or mounted on, depth-controlled cables 210 that are towed behind the survey vessel 110.

In addition to providing a mechanical connection between the buoys 125 and the survey vessel 110, the cables 210 may also provide a communication link between the buoys 125 and the survey vessel 110. For example, the cables 210 may include one or more electrically conductive wires or cables (not shown) that may transmit signals from the buoys 125 to the survey vessel 110. For another example, the cables 210 may include one or more optical fibres (not shown) that may transmit signals from the buoys 125 to the survey vessel 110. However, in alternative embodiments, the cables 210 may not provide a communication connection between the buoys 125 and the survey vessel 110. For example, the buoys 125 may communicate with the survey vessel 110 via a wireless radio-frequency transmission.

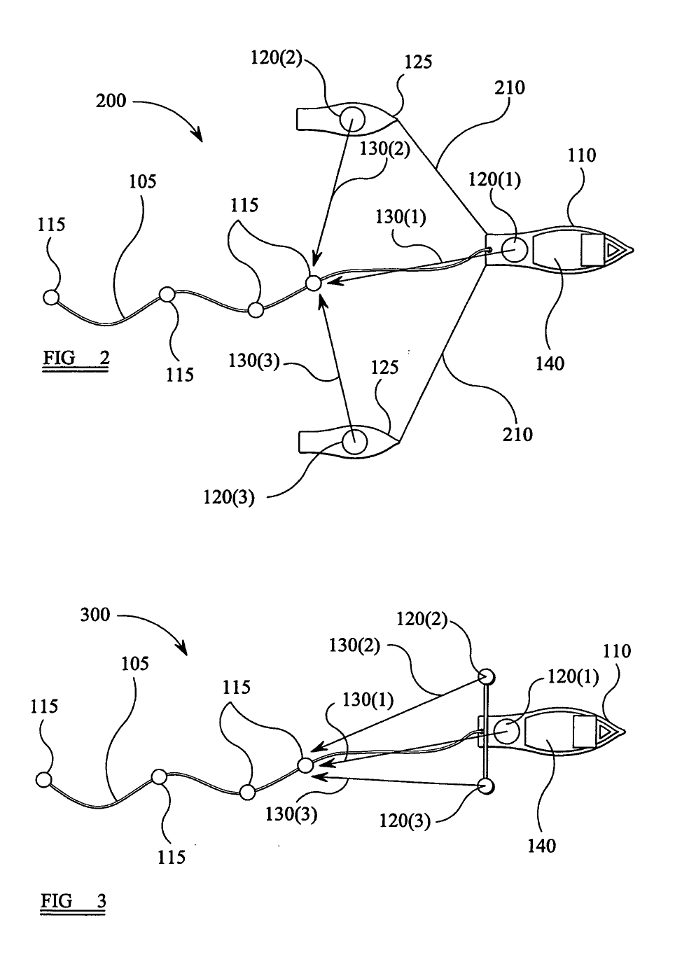

Referring now to FIG. 3, a third exemplary system 300 for acoustic positioning of a seismic cable 105 is shown. In the third exemplary system 300, the sources 120(2-3) are coupled to the survey vessel 110 by a boom 310. In one embodiment, the sources 120(2-3) are suspended from the boom 310 such that the sources 120(2-3) are at least partially submerged in the body of water. The boom 310 may also provide a communication connection between the sources 120(2-3) and the survey vessel 110. For example, the boom 310 may include one or more electrically conductive wires (not shown) that may transmit signals from the sources 120(2-3) to the survey vessel 110. For another example, the boom 310 may include one or more optical fibres (not shown) that may transmit signals from the sources 120(2-3) to the survey vessel 110. However, in alternative embodiments, the boom 310 may not provide a communication connection between the sources 120(2-3) and the survey vessel 110. For example, the sources 120(2-3) may communicate with the survey vessel 110 via a wireless radio-frequency transmission. It will also be appreciated that, in various alternative embodiments, more than one boom 310 may be coupled to the survey vessel 110.

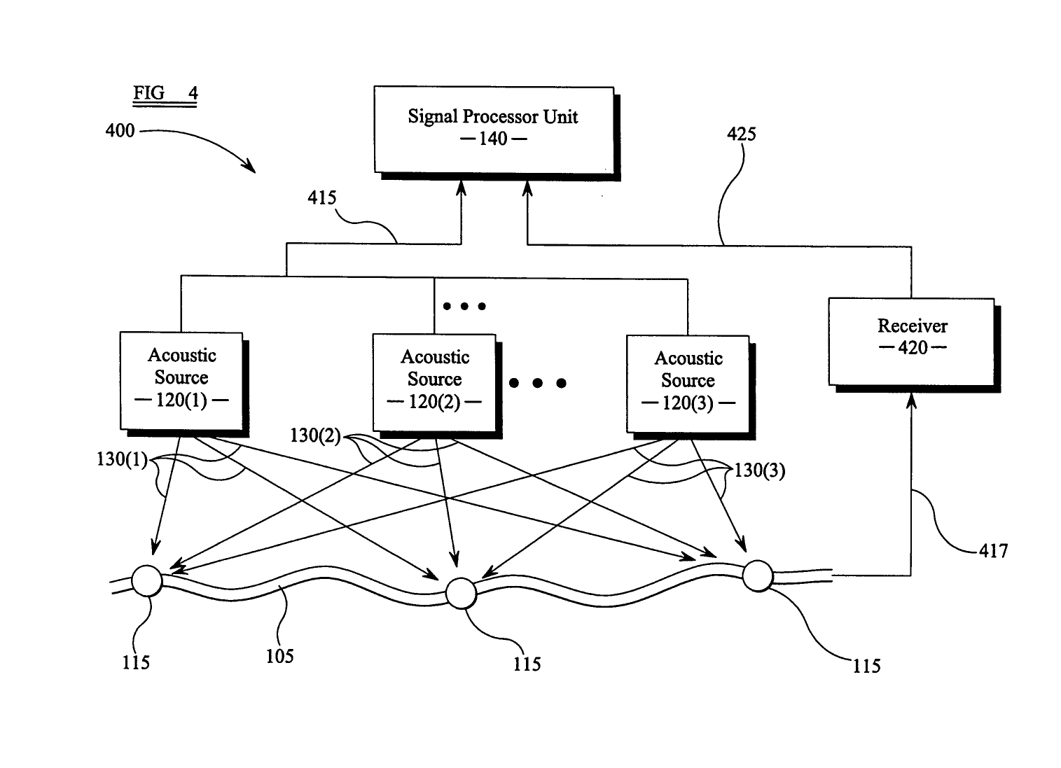

FIG. 4 shows a system 400 for transmitting the positioning signals 130(1-3), in accordance with one embodiment of the present invention. The sources 120(1-3) transmit the plurality of positioning signals 130(1-3), in accordance with one embodiment of the present invention. For example, the sources 120(1-3) may transmit an up-sweep that ranges in frequency from 700 HZ to 2000 Hz. For yet another example, the sources 120(1-3) transmit an up-sweep that ranges in frequency from 1500 HZ to 4500 Hz. However, it will be appreciated by those of ordinary skill in the art having benefit of the present disclosure that the present invention is not so limited. In alternative embodiments, up-sweeps, down-sweeps, and any other desirable pattern having higher and/or lower frequency ranges may be used without departing from the scope of the present invention.

In one alternative embodiment, the sources 120(1-3) may also transmit orthogonal positioning signals 130(1-3). For example, the positioning signals 130(1-3) may be modulated by an orthogonal sequence, such as a Maximal sequence, a Kasami sequence, and the like. In another alternative embodiment, the sources 120(1-3) may be frequency multiplexed.

The sources 120(1-3) also transmit a signal 415 indicative of the positioning signals 130(1-3) to the signal processing unit 140, which may use the signal 415 to determine the position of the seismic sources 115, as described in detail below. The signal processing unit 140 in the system 400 may communicate with the sources 120(1-3) in any of a variety of manners well know to those of ordinary skill in the art having benefit of the present disclosure including, but not limited to, conductive wires, optical fibres, wireless electromagnetic transmissions, and the like. Although the signal processing unit 140 is depicted as a single unit in FIG. 4, the present invention is not so limited. In alternative embodiments, portions (not shown) of the signal processing unit 140 may be positioned on the buoys 125, the survey vessel 110, or any other desirable location without departing from the scope of the present invention.

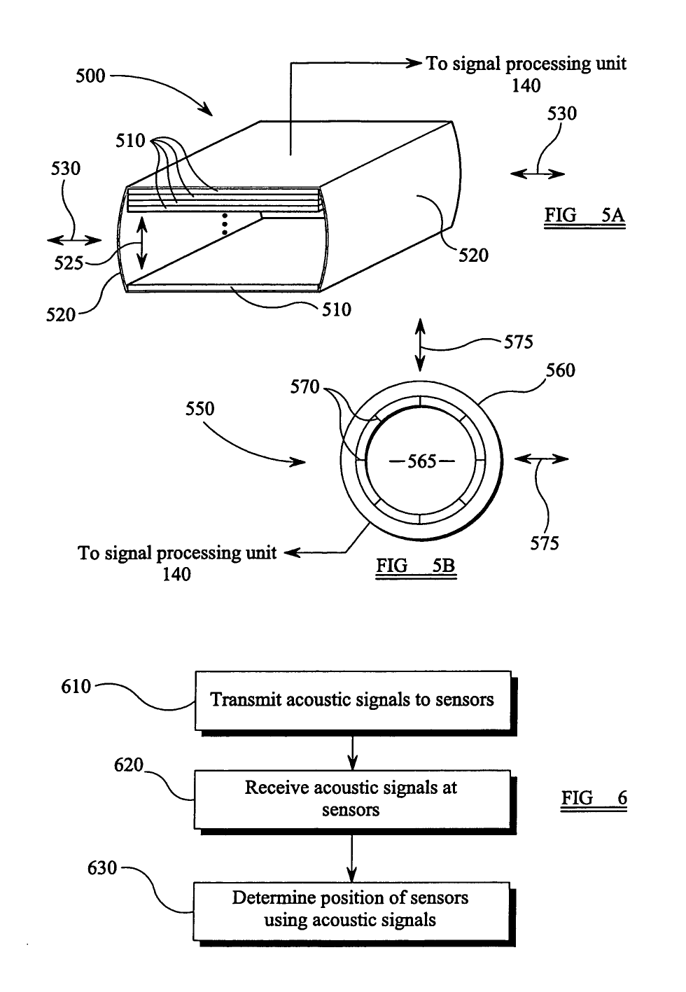

FIG. 5A shows a first exemplary piezoelectric acoustic source 500 that may be used as at least one of the sources 120(1-3). In one embodiment, the first exemplary piezoelectric acoustic source 500 is formed from a plurality of piezoelectric wafers 510 that are coupled to at least one flexible membrane 520. To transmit the positioning signals 130(1-3), the piezoelectric wafers 510 expand and/or contract along the direction indicated by the arrows 525. The flexible membrane 520 moves in response to the expansion and/or contraction of the piezoelectric wafers 510 along the directions indicated by the arrows 530. The motion of the flexible membrane 520 generates the positioning signals 130(1-3).

FIG. 5B shows a second exemplary piezoelectric acoustic source 550 that may be used as at least one of the sources 120(1-3). In one embodiment, the second exemplary piezoelectric acoustic source 550 is formed from a piezoelectric ring 560 that is coupled to an interior flexible membrane 565 by a plurality of connectors 570. Although the piezoelectric ring 560 and the interior flexible membrane 565 have been depicted as circular, the present invention is not so limited. In alternative embodiments, the piezoelectric ring 560 and the interior flexible membrane 565 may be oval, rectangular, triangular, or any other desirable shape without departing from the scope of the present invention.

To transmit the positioning signals 130(1-3), the piezoelectric ring 560 expands and/or contracts along the direction indicated by the arrows 575. The interior flexible membrane 565 moves along the directions indicated by the arrows 575 in response to the expansion and/or contraction of the piezoelectric ring 560 and generates the positioning signals 130(1-3).

Referring back to FIG. 4, in one embodiment, the positioning signals 130(1-3) are received by the sensors 115, which communicate a sensed signal 417 to a receiver 420. For example, the sensors 115 may communicate the sensed signal 417 to the receiver 420 via a data telemetry unit (not shown) included in the sensors 115 and conductive wires (not shown) in the cable 105. However, in alternative embodiments, the sensed signal 417 may be communicated to the receiver 420 in any desirable manner including, but not limited to, wireless transmissions, optical devices, and the like.

In one embodiment, the received signal 417 may include contributions from the positioning signals 130(1-3) and the seismic survey signal 118. When determining the position of the seismic cable 105, it may be desirable to distinguish the contributions from the positioning signals 130(1-3) from the seismic survey signal 118. Thus, in one embodiment, the positioning signals 130(1-3) are distinguishable from the seismic survey signal 118. For example, the seismic survey signal 118 typically ranges in frequency from 0 Hz to 120 Hz. In one embodiment, the positioning signals 130(1-3) have frequencies in the range 700 Hz to 4500 Hz, and are therefore distinguished from the seismic survey signal 118 by frequency. In alternative embodiments, it will be appreciated that portions of this process may be carried out in the sensors 115, the receiver 420, the signal processing unit 140, a combination of the above, or at any other desirable location without departing from the scope of the present invention.

The receiver 420 provides a received signal 425 to the signal processing unit 140. The received signal 425 includes at least the portion of the sensed signal 417 that is contributed by the positioning signals 130(1-3). The receiver 420 may, in one embodiment, record the received signal 425 on tape and then provide the tape to the signal processing unit 140. However, the present invention is not so limited. In alternative embodiments, the receiver 420 may provide the received signal 425 using conductive wires, optical fibers, radio-frequency transmissions, computer disks, and the like.

The signal processing unit 140 determines the locations of the sensors 115 using the received signal 425 and the signal 415. In one embodiment, the signal processing unit 140 may use conventional cross-correlation techniques to determine the distance from the sources 120(1-3) to the sensors 115 using the received signal 425 and the signal 415. The signal processing unit 140 may then triangulate to determine the location of the sensors 115. It will, however, be appreciated that, in alternative embodiments, additional information may be included in the received signal 425 and used to determine the location of the sensors 115. For example, the sensors 115 may determine the bearing of the positioning signals 130(1-3) and the signal processing unit 140 may use the bearing to determine the location of the sensors 115. The bearing of the positioning signals 130(1-3) may also be used to determine the heading of each sensor 115.

FIG. 6 shows a flow chart illustrating a technique for determining the locations of the sensors 115, in accordance with one embodiment of the present invention. One or more positioning signals 130(1-3) are transmitted (at 610) from the sources 120(1-3), which are structurally independent of the sensors 115, to the sensors 115, in the manner described in detail above. In one embodiment, a piezoelectric acoustic source 500, 600 transmits (at 610) the positioning signals 130(1-3) to sub-sea sensors 115 in a marine environment. In another embodiment, an airgun transmits (at 610) the positioning signals 130(1-3) to sub-sea sensors 115 in a marine environment. The positioning signals 130(1-3) are received (at 620) by one or more sensors 115 and, as described above, the position of the sensors 115 is determined (at 630). For example, in one embodiment, the position of the sensors is determined (at 630) by determining (at 630) the distances from the sources 120(1-3) to the sensors 115 and then triangulating.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1-43. (canceled)

44. An apparatus, comprising:
at least one seismic sensor deployed on an ocean bottom cable; and
a plurality of sources deployed in a manner structurally independent of the seismic sensors and adapted to provide, to the or each seismic sensor, a positioning signal distinguishable from a seismic survey signal to the seismic sensors concurrently with the seismic survey signal.

45. The apparatus of claim 44, wherein the sources are adapted to provide the positioning signal at a frequency outside the bandwidth of the seismic survey signal.

46. The apparatus of claim 45, wherein the sources are adapted to provide the positioning signal at a frequency above the bandwidth of the seismic survey signal.

47. The apparatus of claim 46, wherein the sources are adapted to provide the positioning signal having a frequency bandwidth.

48. The apparatus of claim 47, wherein the frequency bandwidth is approximately 700 Hz to 2000 Hz.

49. The apparatus of claim 47, wherein the frequency bandwidth is approximately 1500 Hz to 4500 Hz.

50. The apparatus of claim 44, wherein the plurality of sources comprises between two and five sources, inclusive.

51. The apparatus of claim 50, wherein the plurality of sources comprises three sources.

52. The apparatus of claim 44, wherein the plurality of sources are piezoelectric sources.

53. The apparatus of claim 44, further comprising a signal processing unit adapted to determine the position of the seismic sensors from the received positioning signal.

54. The apparatus of claim 53, wherein the signal processing unit is adapted to determine the position of the seismic sensors using a plurality of propagation times from the plurality of sources to the at least one seismic sensor.

55. The apparatus of claim 54, wherein the signal processing unit is adapted to determine the position of the seismic sensors by triangulation using the plurality of propagation times from the plurality of sources to the at least one seismic sensor.

56. An apparatus, comprising:
at least one seismic sensor deployed on a sea bed; and
a plurality of sources adapted to provide to the seismic sensors a positioning signal distinguishable from a seismic survey signal concurrently with the seismic survey signal.

57. The apparatus of claim 56, wherein the sources are adapted to provide the positioning signal at a frequency outside the bandwidth of the seismic survey signal.

58. The apparatus of claim 57, wherein the sources are adapted to provide the positioning signal at a frequency above the bandwidth of the seismic survey signal.

59. The apparatus of claim 58, wherein the sources are adapted to provide the positioning signal having a frequency bandwidth.

60. The apparatus of claim 59, wherein the frequency bandwidth range is approximately 700 Hz to 2000 Hz.

61. The apparatus of claim 60, wherein the frequency bandwidth range is approximately 1500 Hz to 4500 Hz.

62. A method for determining a position of at least one seismic sensor deployed on an ocean bottom cable and capable of receiving a seismic survey signal, comprising:
transmitting a plurality of positioning signals from a plurality of sources deployed in a manner that is structurally independent of the seismic sensors, the positioning signals being distinguishable from the seismic survey signal;
receiving the positioning signals at the seismic sensors concurrently with the seismic survey signal; and
determining the position of the seismic sensors from the received positioning signals.

63. The method of claim 62, wherein transmitting the plurality of positioning signals comprises transmitting the positioning signals at a frequency outside the bandwidth of the seismic survey signal.

64. The method of claim 63, wherein transmitting the plurality of positioning signals comprises transmitting the positioning signals at a frequency above the bandwidth of the seismic survey signal.

65. The method of claim 62, wherein determining the position of the seismic sensors using the received signals comprises determining a plurality of propagation times from the sources to the seismic sensors using the received signals.

66. The method of claim 65, wherein determining the position of the seismic sensors comprises determining the position of the seismic sensors using the plurality of propagation times.

67. The method of claim 66, wherein determining the position of the seismic sensors using the plurality of propagation times comprises determining the position of the sensors by triangulation using the plurality of propagation times.

68. A method, comprising;
transmitting a plurality of positioning signals from a plurality of sources, the positioning signals being distinguishable from the seismic survey signal;
receiving, concurrently with the seismic survey signal, the positioning signals at a plurality of seismic sensors deployed on a sea bed; and
determining the position of the seismic sensors from the received positioning signals.

69. The method of claim 68, wherein transmitting the plurality of positioning signals comprises transmitting the positioning signals at a frequency outside the bandwidth of the seismic survey signal.

70. The method of claim 69, wherein determining the position of the seismic sensors using the received signals comprises determining a plurality of propagation times from the sources to the seismic sensors using the received signals.

71. A system, comprising:
a vessel;
an ocean bottom seismic cable having at least one seismic sensor capable of receiving a seismic survey signal concurrently with a positioning signal that is distinguishable from the seismic survey signal, wherein the seismic cable is deployed from the vessel;
a plurality of buoys;
a plurality of sources adapted to provide the positioning signal, at least one source being suspended beneath the survey vessel and the remainder being deployed on the buoys; and
a signal processing unit adapted to determine the position of the seismic sensors from the received positioning signals.

72. The system of claim 71, wherein the buoys are autonomous self-propelled buoys.

73. The system of claim 71, wherein the buoys are towed behind the survey vessel.

74. (not presented)

75. A system, comprising:
at least one seismic sensor deployed on an ocean bottom cable and capable of receiving a seismic survey signal concurrently with a positioning signal that is distinguishable from the seismic survey signal;
a plurality of autonomous self-propelled buoys; and
a plurality of sources coupled to the self-propelled autonomous buoys, the sources being adapted to provide the positioning signal.

76. The system of claim 75, wherein the sources are suspended beneath the autonomous self-propelled buoys.

77. The system of claim 75, further comprising a signal processing unit adapted to determine the position of the seismic sensors using the received positioning signals.

78. (canceled)

79. A system, comprising:
a first vessel;
an ocean bottom seismic cable having at least one seismic sensor capable of receiving a seismic survey signal concurrently with a positioning signal that is distinguishable from the seismic survey signal, wherein the seismic cable is deployed from the first vessel;
a second vessel;
a plurality of buoys;
a plurality of sources adapted to provide a positioning signal, at least one source being coupled to the first vessel, at least one source being coupled to the second vessel, and the remainder being deployed on the buoys; and
a signal processing unit adapted to determine the position of the seismic sensors from the received positioning signals.

80. The system of claim 79, wherein at least a portion of the buoys are deployed along a length of the seismic cable.

81. The system of claim 79, further comprising an array of seismic cables having at least one seismic sensor capable of receiving the seismic survey signal.

82. The system of claim 81, wherein at least a portion of the buoys are deployed among the array of seismic cables.
